(19) United States
(12) Patent Application Publication
(10) Pub. No.: US 2024/0362561 A1
(43) Pub. Date: Oct. 31, 2024

(54) SYSTEM AND METHOD FOR MANAGING DATA WORKFLOWS USING DIGITAL TWINS

(71) Applicant: Dell Products L.P., Round Rock, TX (US)

(72) Inventors: OFIR EZRIELEV, Be'er Sheva (IL); TOMER KUSHNIR, Omer (IL); MAXIM BALIN, Gan-Yavne (IL)

(21) Appl. No.: 18/309,243

(22) Filed: Apr. 28, 2023

(51) Int. Cl. G06Q 10/0631; G06Q 10/0639

(52) U.S. Cl. CPC G06Q 10/06316; G06Q 10/0639

(57) ABSTRACT

Methods and systems for managing data workflows performed by data processing systems throughout a distributed environment are disclosed. To manager data workflows, a system may include a data workflow manager and one or more data processing systems. The data workflow manager may host and operate a digital twin intended to duplicate operation of each corresponding data processing system involved in a data workflow. In the event of a loss of functionality of a data processing system involved in the data workflow, the data workflow manager may initiate operation of a corresponding digital twin and re-route the data workflow through the digital twin to facilitate continued performance of computer-implemented services based on the data workflow. When a replacement data processing system becomes available, the replacement data processing system may be inserted into the data workflow and the digital twin may no longer be used.

### FIELD

Embodiments disclosed herein relate generally to managing data workflows. More particularly, embodiments disclosed herein relate to systems and methods for managing interruptions to data workflows performed by data processing systems throughout a distributed environment.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a block diagram illustrating a data workflow performed by data processing systems in accordance with an embodiment.

FIG. 2B shows a block diagram illustrating a first updated data workflow performed by data processing systems and a digital twin in accordance with an embodiment.

FIG. 2C shows a block diagram illustrating a second updated data workflow performed by data processing systems in accordance with an embodiment.

FIG. 3 shows a flow diagram illustrating a method of managing a data workflow performed by data processing systems throughout a distributed environment in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

In general, embodiments disclosed herein relate to methods and systems for managing a data workflow performed by data processing systems throughout a distributed environment. To manage the data workflow, the system may include a data workflow manager. The data workflow manager may oversee performance of computer-implemented services facilitated by the data workflow. Interruptions to the data workflow (e.g., due to, for example, replacement of a data processing system, etc.) may impact the quality and/or availability of the computer-implemented services (e.g., due to system downtime, etc.).

Specifically, there may be a time delay between removal of a data processing system from the data workflow and replacement of the data processing system in the data workflow. The time delay may occur due to, for example, lead time required to fabricate, test, and deliver a replacement data processing system to a desired location.

To avoid interruptions to the data workflow and, therefore, interruptions to the provided computer-implemented services, the data workflow manager may host and operate a digital twin of each data processing system in the data workflow. If one or more data processing systems in the data workflow requires replacement, the data workflow manager may initiate operation of a corresponding digital twin and re-route the data workflow through the digital twin to continue providing the computer-implemented services until a replacement data processing system becomes available.

When the replacement data processing system becomes available, the replacement data processing system may be integrated into the data workflow and the digital twin may be removed from the data workflow. By doing so, interruptions to the computer-implemented services facilitated by the data workflow may be reduced throughout the distributed environment.

In an embodiment, a method of managing data processing systems responsible for performing a data workflow throughout a distributed environment is provided. The method may include: identifying an occurrence of an event indicating that a first data processing system of the data processing systems requires replacement in the data workflow; based on the occurrence of the event: initiating operation of a digital twin, the operation of the digital twin being intended to duplicate operation of the first data processing system, and the operation of the digital twin being substituted in the data workflow for the operation of the first data processing system in the data workflow to obtain a first updated data workflow; after a second data processing system becomes available for replacement of the first data processing system, discontinuing use of the operation of the digital twin in the first updated data workflow and substituting operation of the second data processing system in the first updated data workflow for the operation of the digital twin in the first updated data workflow to obtain a second updated data workflow; after obtaining the second updated data workflow: performing an analysis for the digital twin and based on test operation of the second data processing system and test operation of the digital twin to obtain a digital twin performance report; and performing an action set based on the digital twin performance report.

The data workflow facilitates providing computer-implemented services to a downstream consumer and removing the first data processing system from the data workflow interrupts the computer-implemented services if the operation of the digital twin does not replace the operation of the first data processing system.

The data workflow may include: a data collector located in a first position in the data workflow; the first data processing system located in a second position in the data workflow; and a third data processing system located in a third position in the data workflow.

The first updated data workflow may include: the data collector; the digital twin located in a data center, the data center not being located in the second position in the data workflow; and the third data processing system.

There may be a time delay between the occurrence of the event and the second data processing system becoming available for replacement of the first data processing system in the data workflow.

Initiating the operation of the digital twin may include: identifying the duration of the time delay; and selecting characteristics of the digital twin based on the duration; and temporarily substituting the operation of the digital twin for the operation of the first data processing system in the first updated data workflow for the duration, wherein there is an expected difference in performance between the operation of the digital twin and the operation of the second data processing system.

Temporarily substituting the operation of the digital twin for the operation of the first data processing system may include: obtaining the digital twin based on the selected characteristics; obtaining first input data for the digital twin from the data collector, the first input data being intended to be processed by the first data processing system in the data workflow; obtaining first output data using the first input data and the digital twin; and providing the first output data to the third data processing system.

Performing the analysis for the digital twin may include: obtaining second output data using the second data processing system and the first input data; obtaining a difference between the second output data and the first output data; and obtaining the digital twin performance report using, at least in part, the difference.

Performing the analysis for the digital twin may include: obtaining second output data using the second data processing system and second input data; obtaining third output data using the digital twin and the second input data; obtaining a difference between the second output data and the third output data; and obtaining the digital twin performance report using, at least in part, the difference.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

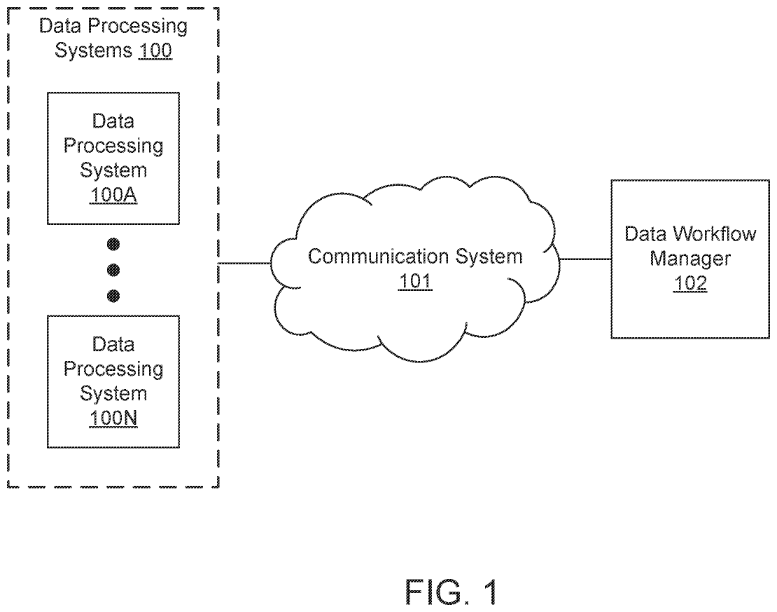

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include monitoring services (e.g., of locations), communication services, and/or any other type of computer-implemented services.

To provide the computer-implemented services, the system may include data workflow manager 102. Data workflow manager 102 may provide all, or a portion of, the computer-implemented services. For example, data workflow manager 102 may provide computer-implemented services to users of data workflow manager 102 and/or other computing devices operably connected to data workflow manager 102.

To facilitate performance of the computer-implemented services, the system may include one or more data processing systems 100. Data processing systems 100 may include any number of data processing systems (e.g., 100A-100N). For example, data processing systems 100 may include one data processing system (e.g., 100A) or multiple data processing systems (e.g., 100A-100N) that may independently and/or cooperatively facilitate the computer-implemented services.

All, or a portion, of data processing systems 100 may provide (and/or participate in and/or support the) computer-implemented services to various computing devices operably connected to data processing systems 100. Different data processing systems may provide similar and/or different computer-implemented services.

When providing the computer-implemented services, the system of FIG. 1 may manage data workflows performed by data processing systems throughout a distributed environment.

Over time, one or more data processing systems involved in a data workflow may require replacement (e.g., due to malfunction of a data processing system, scheduled maintenance and/or upgrades to the data processing system, etc.) and/or may be removed (e.g., temporarily removed, permanently removed, etc.) from the data workflow for other reasons. There may be a time delay associated with replacing the data processing system in the data workflow. The time delay may interrupt and/or impact the quality of the computer-implemented services facilitated by the data workflow.

In general, embodiments disclosed herein may provide methods, systems, and/or devices for reducing interruptions to a data workflow. To do so, the system of FIG. 1 may host and operate a digital twin of each data processing system throughout the distributed environment involved in the data workflow. Each digital twin may be intended to duplicate operation of a corresponding data processing system. The digital twins may be hosted and operated out of a data center and, in the event of a loss of functionality of a data processing system, the data workflow may be re-routed through the digital twin (in the data center) to continue providing computer-implemented services until a replacement data processing system becomes available.

When the replacement data processing system becomes available, the data workflow may be re-routed again through the replacement data processing system and the digital twin may no longer be used to facilitate the data workflow.

Following addition of the replacement data processing system to the data workflow, the past performance of the digital twin in the data workflow may be evaluated. Doing so may help determine the quality of the computer-implemented services provided to a downstream consumer during the duration of the time delay.

To provide the above noted functionality, the system of FIG. 1 may include data workflow manager 102. Data workflow manager 102 may (i) identify an occurrence of an event indicating that a first data processing system requires replacement, (ii) initiate operation of a digital twin to obtain a first updated data workflow (iii) after a second data processing system becomes available for replacement of the first data processing system, discontinue use of the operation of the digital twin and substitute operation of the second data processing system for operation of the digital twin to obtain a second updated data workflow, (iv) perform an analysis for the digital twin to obtain a digital twin performance report, and/or (v) perform an action set based on the digital twin performance report.

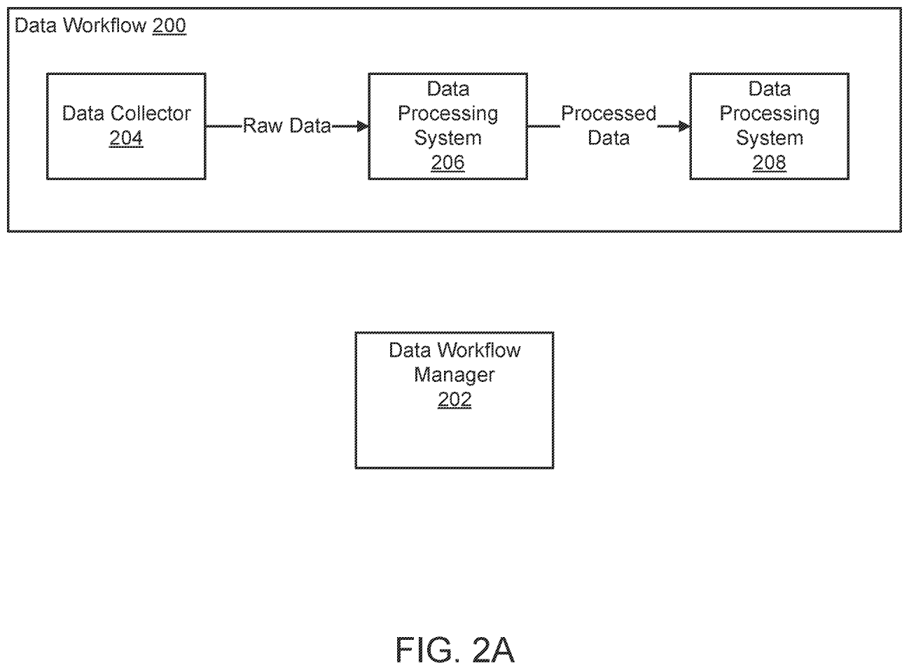

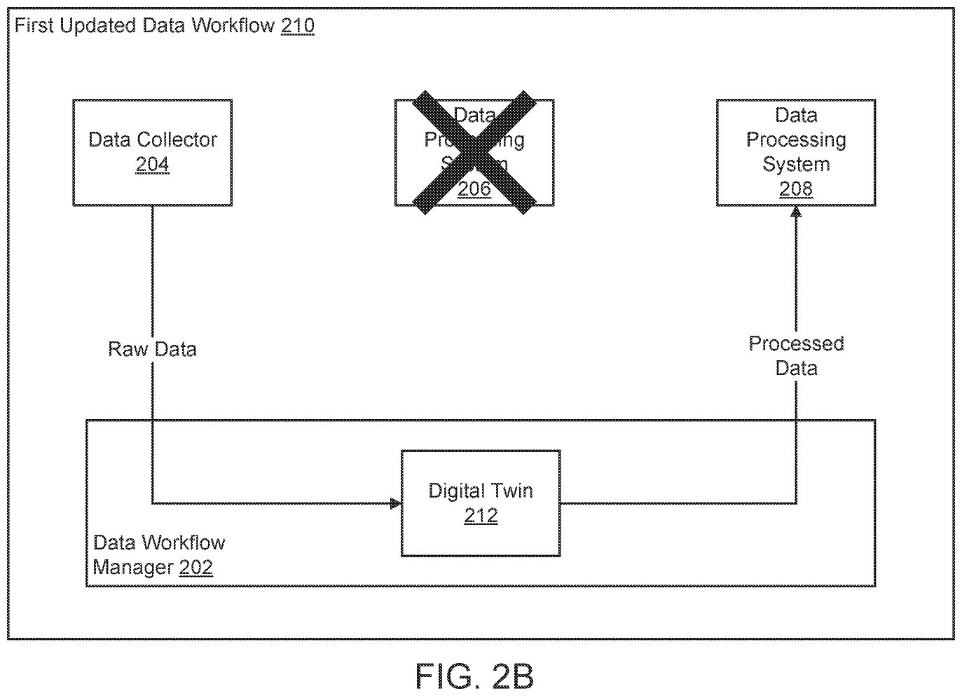

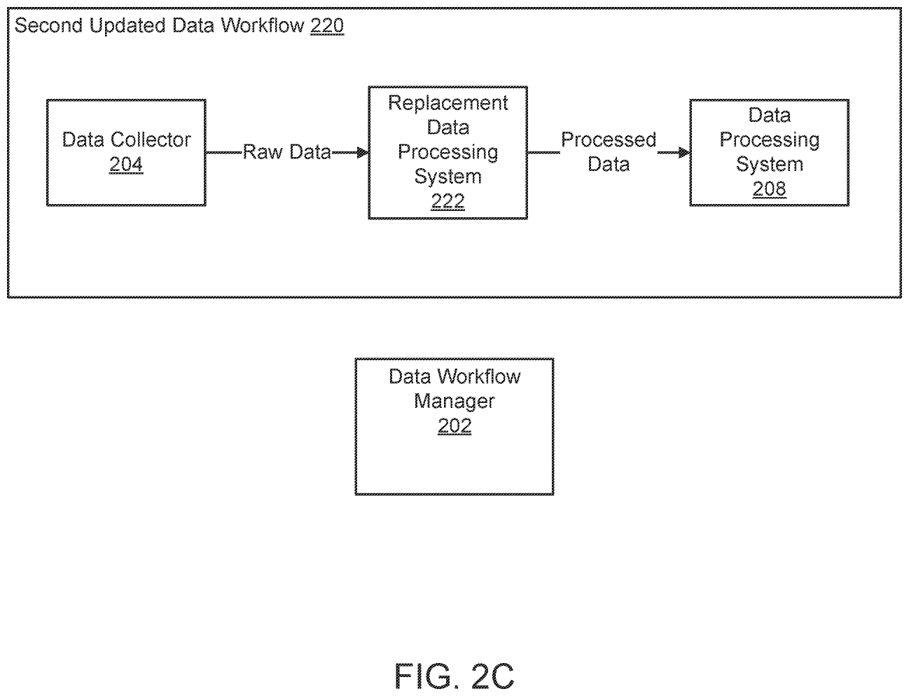

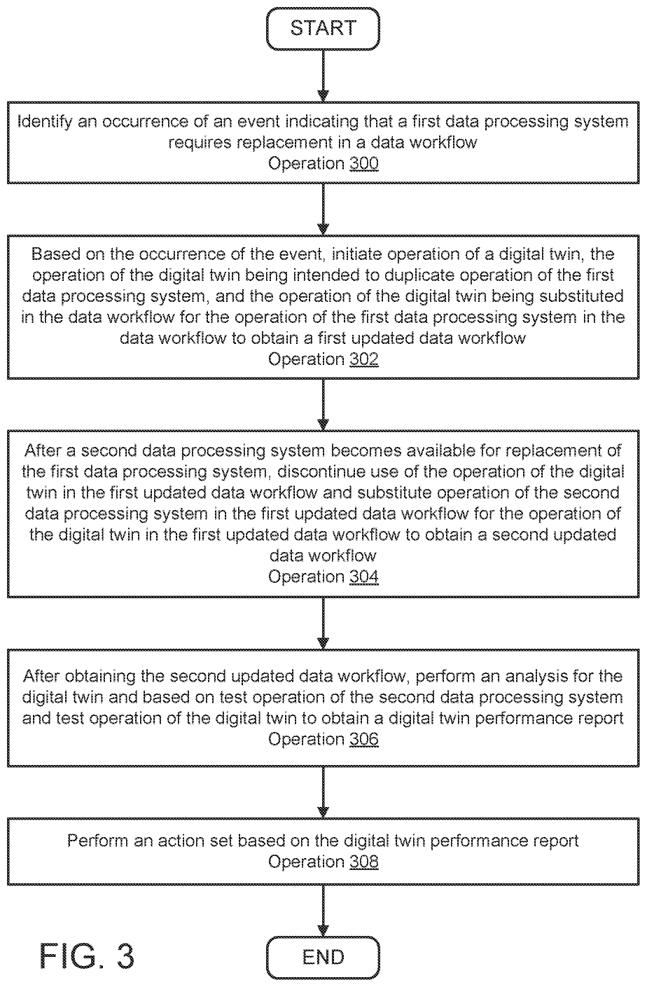

When performing its functionality, data workflow manager 102 and/or data processing systems 100 may perform all, or a portion, of the methods and/or actions shown in FIGS. 2A-3.

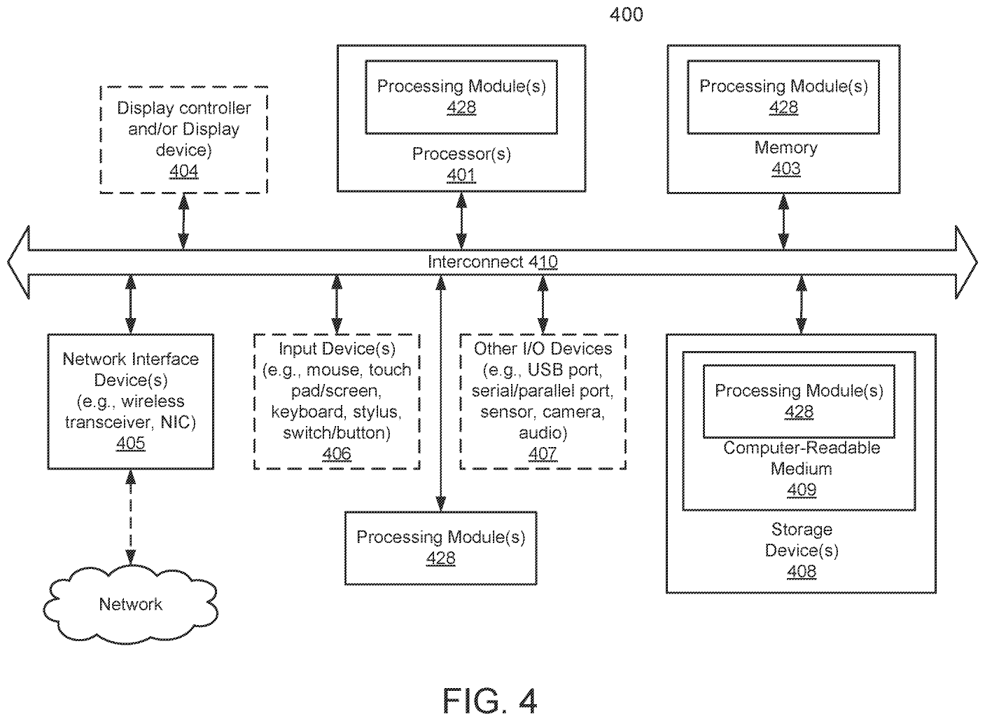

Data processing systems 100 and/or data workflow manager 102 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

In an embodiment, one or more of data processing systems 100 and/or data workflow manager 102 are implemented using an internet of things (IoT) device, which may include a computing device. The IoT device may operate in accordance with a communication model and/or management model known to data workflow manager 102, other data processing systems, and/or other devices.

Any of the components illustrated in FIG. 1 may be operably connected to each other (and/or components not illustrated) with a communication system 101. In an embodiment, communication system 101 may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, diagrams illustrating data flows and/or processes performed in a system in accordance with an embodiment are shown in FIGS. 2A-2C.

FIG. 2A shows a block diagram of data workflow manager 202 monitoring data workflow 200 in accordance with an embodiment. Data workflow manager 202 may be similar to data workflow manager 102 shown in FIG. 1. In FIG. 2A, data workflow manager 202 may be connected to data workflow 200 via a communication system (not shown). Data workflow 200 may include any number of devices (e.g., data collectors, data processing systems, etc.) and each device may be similar to any of data processing systems 100 shown in FIG. 1.

In FIG. 2A, data workflow 200 may include data collector 204, data processing system 206, and data processing system 208. Communications between data collector 204, data processing system 206, and data processing system 208 are illustrated using lines terminating in arrows.

In FIG. 2A, data collector 204 may be located in a first position in data workflow 200 and may collect raw data representative of an environment (e.g., temperature data, video surveillance footage, etc.) and may provide the raw data to data processing system 206. Data processing system 206 may be located in a second position in data workflow 200 and may perform an analysis of the raw data (e.g., an anomaly detection process, etc.) to obtain processed data (e.g., a report identifying anomalies in the raw data). Data processing system 206 may provide the processed data to data processing system 208. Data processing system 208 may be located in a third position in data workflow 200 and may be responsible for performing actions in response to the processed data, such as providing computer-implemented services to a downstream consumer.

Turning to FIG. 2B, data processing system 206 may malfunction and, therefore, may be removed from data workflow 200. As previously mentioned, data workflow 200 may facilitate computer-implemented services provided to a downstream consumer and removing data processing system 206 from data workflow 200 may interrupt the computer-implemented services. To re-establish the functionality of data workflow 200, a replacement data processing system may be requested to fill the gap in data workflow 200 left by data processing system 206.

However, there may be a time delay between the malfunctioning of data processing system 206 and the replacement data processing system becoming available.

To reduce interruptions to the computer-implemented services for the duration of the time delay, data workflow manager 202 may host an operate digital twin 212. Data workflow manager may host and operate digital twin 212 out of a data center, the data center not being located in the first position, second position, or third position of data workflow 200.

By operating digital twin 212, data workflow manager 202 may establish first updated data workflow 210. First updated data workflow 210 may include data collector 204, digital twin 212, and data processing system 208. Digital twin 212 may operate software identical to and/or representative of software previously operated by data processing system 206. Characteristics of digital twin 212 may be selected by data workflow manager 202 based on a duration of the expected time delay. For example, a more complex (and, therefore, more accurate) version of digital twin 212 may be selected for a longer duration of the time delay. Therefore, there may be an expected difference in performance between the operation of digital twin 212 and the operation of the replacement data processing system.

Turning to FIG. 2C, replacement data processing system 222 may become available to replace the operation of digital twin 212 in first updated data workflow 210. By replacing the operation of digital twin 212 with the operation of replacement data processing system 222, second updated data workflow 220 may be obtained. In second updated data workflow 220, data collector 204 may transmit the raw data to replacement data processing system 222 and replacement data processing system 222 may transmit the processed data to data processing system 208. Consequently, digital twin 212 may no longer be required to facilitate continued performance of the computer-implemented services.

Following obtaining second updated data workflow 220, the performance of digital twin 212 in first updated data workflow 210 may be evaluated by data workflow manager 202. This may be done, for example, by comparing processed data obtained by digital twin 212 and from replacement data processing system 222 given the same raw data (not shown). Refer to FIG. 3 for additional details regarding evaluating the performance of digital twins.

In an embodiment, data workflow manager 202 is implemented using a processor adapted to execute computing code stored on a persistent storage that when executed by the processor performs the functionality of data workflow manager 202 discussed throughout this application. The processor may be a hardware processor including circuitry such as, for example, a central processing unit, a processing core, or a microcontroller. The processor may be other types of hardware devices for processing information without departing from embodiments disclosed herein.

As discussed above, the components of FIG. 1 may perform various methods to manage a data workflow performed by data processing systems throughout a distributed environment. FIG. 3 illustrates methods that may be performed by the components of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing a data workflow performed by data processing systems throughout a distributed environment in accordance with an embodiment is shown. The method may be performed, for example, by a data workflow manager, data processing system, and/or any other device.

At operation 300, an occurrence of an event indicating that a first data processing system requires replacement in a data workflow is identified.

Identifying the occurrence of the event may include: (i) receiving a notification from an entity (the first data processing system and/or any other entity throughout the distributed environment) indicating that the first data processing system requires replacement (due to, for example, malfunction of the first data processing system), (ii) failing to receive an expected communication from the first data processing system and, therefore, concluding that the first data processing system has malfunctioned, (iii) removing the first data processing system from the data workflow (in response to an aging out of the first data processing system, etc.), and/or other actions.

At operation 302, based on the occurrence of the event, operation of a digital twin is initiated. The operation of the digital twin may be intended to duplicate operation of the first data processing system. The operation of the digital twin may be substituted in the data workflow for the operation of the first data processing system to obtain the first updated data workflow.

Initiating operation of the digital twin may include: (i) identifying the duration of the time delay, (ii) selecting characteristics of the digital twin based on the duration, and/or (iii) temporarily substituting the operation of the digital twin for the operation of the first data processing system in the first updated data workflow for the duration.

The duration of the time delay may be identified by: (i) receiving a message from an entity indicating an expected amount of time required for fabrication and delivery of the data processing system, (ii) reading the duration of the time delay from storage, (iii) feeding an identifier of the first data processing system into an inference model trained to predict durations of time delays, and/or via other methods.

Characteristics of the digital twin may be selected using a digital twin lookup table and the duration as a key for the digital twin lookup table. The digital twin lookup table may include a list of digital twins (with varying complexity) and corresponding durations of time delays. For example, more complex digital twins may be associated with longer time delays, as the digital twin may be required to stand in for a data processing system for a longer duration.

Characteristics of the digital twin may be selected via other methods without departing from embodiments disclosed herein.

Temporarily substituting the operation of the digital twin for the operation of the first data processing system may include: (i) obtaining the digital twin based on the selected characteristics, (ii) obtaining first input data for the digital twin from the data collector, the first input data being intended to be processed by the first data processing system in the data workflow, (iii) obtaining first output data using the first input data and the digital twin, and/or (iv) providing the first output data to the third data processing system.

Obtaining the digital twin based on the selected characteristics may include: (i) reading the digital twin from storage (e.g., via a lookup table with the characteristics as a key for the lookup table), (ii) obtaining the digital twin from another entity responsible for hosting and/or generating digital twins (e.g., via transmitting the characteristics to the entity and receiving the digital twin in response to the transmission, etc.), (iii) generating the digital twin, and/or other methods. The digital twin may be generated, for example, by obtaining a copy of software executed by the data processing system to perform computer-implemented services.

Obtaining the first input data for the digital twin from the data collector may include: (i) receiving a transmission from a data processing system (e.g., the data collector, another data processing system associated with the data workflow, etc.) including data obtained by one or more sensors associated with the data collector, (ii) reading the first input data from storage, (iii) transmitting a request to the data collector for the first input data and receiving the first input data as a response to the request, (iv) by receiving a transmission including instructions for retrieving the first input data from a database, and/or other methods.

Obtaining the first output data may include: (i) generating the first output data using the digital twin and the first input data (e.g., by feeding the first input data into the digital twin and obtaining the first output data as output from the digital twin), (ii) by obtaining the first output data from another entity responsible for operating the digital twin, (iii) by reading the first output data from storage, and/or (iv) other methods without departing from embodiments disclosed herein.

Providing the first output data to the third data processing system may include: (i) transmitting the first output data (e.g., in the form of a message, a notification in an application, etc.) to the third data processing system over a communication system, (ii) providing the first output data to another entity responsible for transmitting the first output data to the third data processing system, (iii) transmitting access credentials to the third data processing system, the access credentials allowing the third data processing system to access the first output data from a database, and/or (iv) other methods.

At operation 304, after a second data processing system becomes available for replacement of the first data processing system, the use of the operation of the digital twin in the first updated data workflow is discontinued. Operation of the second data processing system in the first updated data workflow may be substituted for the operation of the digital twin in the first updated data workflow to obtain a second updated data workflow.

Discontinuing the use of the operation of the digital twin in the first updated workflow may include: (i) deactivating the digital twin, (ii) transmitting instructions to the data collector to no longer transmit input data to the digital twin, (iii) transmitting an request to deactivate the digital twin to another entity responsible for operation of the digital twin, and/or other actions.

Substituting the operation of the second data processing system in the first updated data workflow for the operation of the digital twin in the first updated data workflow may include: (i) obtaining the second data processing system, and/or (ii) deploying the second data processing system to a location previously occupied by the first data processing system.

Substituting the operation of the second data processing system in the first updated data workflow for the operation of the digital twin in the first updated data workflow may also include: transmitting instructions to data processing systems throughout the distributed environment (e.g., the data collector and the third data processing system) indicating that the second data processing system has become available, (ii) transmitting a message to the data collector including instructions to provide raw data to the second data processing system rather than the digital twin, (iii) transmitting a message to the third data processing system including instructions to receive processed data from the second data processing system rather than the digital twin, and/or other actions.

Substituting the operation of the second data processing system in the first updated data workflow for the operation of the digital twin in the first updated data workflow may also include transmitting instructions for performing the substitution to another entity responsible for modifying data workflows.

At operation 306, an analysis is performed for the digital twin after obtaining the second updated data workflow and based on test operation of the second data processing system and test operation of the digital twin to obtain a digital twin performance report.

In a first example, performing the analysis for the digital twin may include: (i) obtaining second output data using the second data processing system and the first input data, (ii) obtaining a difference between the second output data and the first output data, and/or (iii) obtaining the digital twin performance report, using, at least in part, the difference.

Obtaining the second output data may include: (i) generating the second output data using the second data processing system and the first input data (e.g., by feeding the first input data into the second data processing system and obtaining the second output data as output from the second data processing system), (ii) by obtaining the second output data from another entity responsible for operating the second data processing system, (iii) by reading the second output data from storage, and/or (iv) other methods without departing from embodiments disclosed herein.

Obtaining the difference may include: (i) obtaining a numerical representation of the first output data (e.g., the full set of the first output data, an average value of the first output data, and/or any other representation), (ii) obtaining a numerical representation of the second output data (e.g., the full set of the second output data, an average value of the second output data, and/or any other representation), and/or (iii) performing a subtraction process using the numerical representation of the first output data and the numerical representation of the second output data to obtain the difference. For example, each data point in the first output data may be subtracted from each corresponding data point in the second output data, the average of the first output data may be subtracted from the average of the second output data, etc.

The difference may be based on other representations of the first output data and the second output data, and the difference may be obtained via other methods (e.g., transmitting the first output data and the second output data to another entity responsible for generating the difference, etc.) without departing from embodiments disclosed herein.

Obtaining the digital twin performance report may include: (i) generating the digital twin performance report, (ii) reading the digital twin performance report from storage, (iii) receiving the digital twin performance report in the form of a message transmitted from another entity, and/or other methods. The digital twin performance report may be generated by generating (or otherwise obtaining) a data structure and populating the data structure using at least the difference.

In a second example, performing the analysis for the digital twin may include: (i) obtaining second output data using the second data processing system and second input data, (ii) obtaining third output data using the digital twin and the second input data, (iii) obtaining a difference between the second output data and the third output data, and/or (iv) obtaining the digital twin performance report using, at least in part, the difference.

Obtaining the second output data may include: (i) generating the second output data using the second data processing system and the second input data (e.g., by feeding the second input data into the second data processing system and obtaining the second output data as output from the second data processing system), (ii) by obtaining the second output data from another entity responsible for operating the second data processing system, (iii) by reading the second output data from storage, and/or (iv) other methods without departing from embodiments disclosed herein.

Obtaining the third output data may include: (i) generating the third output data using the digital twin and the second input data (e.g., by feeding the second input data into the digital twin and obtaining the third output data as output from the digital twin), (ii) by obtaining the third output data from another entity responsible for operating the digital twin, (iii) by reading the third output data from storage, and/or (iv) other methods without departing from embodiments disclosed herein.

Obtaining the difference may include: (i) obtaining a numerical representation of the second output data (e.g., the full set of the second output data, an average value of the second output data, and/or any other representation), (ii) obtaining a numerical representation of the third output data (e.g., the full set of the third output data, an average value of the third output data, and/or any other representation), and/or (iii) performing a subtraction process using the numerical representation of the second output data and the numerical representation of the third output data to obtain the difference. For example, each data point in the second output data may be subtracted from each corresponding data point in the third output data, the average of the second output data may be subtracted from the average of the third output data, etc.

The difference may be based on other representations of the second output data and the third output data, and the difference may be obtained via other methods (e.g., transmitting the second output data and the third output data to another entity responsible for generating the difference, etc.) without departing from embodiments disclosed herein.

Obtaining the digital twin performance report may include: (i) generating the digital twin performance report, (ii) reading the digital twin performance report from storage, (iii) receiving the digital twin performance report in the form of a message transmitted from another entity, and/or other methods. The digital twin performance report may be generated by generating (or otherwise obtaining) a data structure and populating the data structure using at least the difference.

At operation 308, an action set is performed based on the digital twin performance report.

Performing the action set may include: (i) making a determination regarding whether the difference exceeds a threshold (indicated by a downstream consumer and/or any other entity), (ii) notifying the downstream consumer if the difference exceeds the threshold, (iii) terminating operation of the digital twin, and/or other actions.

The method may end following operation 308.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows© operating system from Microsoft©, Mac OS©/iOS© from Apple, Android© from Google©, Linux©, Unix©, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing data processing systems responsible for performing a data workflow throughout a distributed environment, the method comprising:
identifying an occurrence of an event indicating that a first data processing system of the data processing systems requires replacement in the data workflow;
based on the occurrence of the event:
initiating operation of a digital twin, the operation of the digital twin being intended to duplicate operation of the first data processing system, and the operation of the digital twin being substituted in the data workflow for the operation of the first data processing system in the data workflow to obtain a first updated data workflow;
after a second data processing system becomes available for replacement of the first data processing system, discontinuing use of the operation of the digital twin in the first updated data workflow and substituting operation of the second data processing system in the first updated data workflow for the operation of the digital twin in the first updated data workflow to obtain a second updated data workflow;
after obtaining the second updated data workflow:
performing an analysis for the digital twin and based on test operation of the second data processing system and test operation of the digital twin to obtain a digital twin performance report; and
performing an action set based on the digital twin performance report.

2. The method of claim 1, wherein the data workflow facilitates providing computer-implemented services to a downstream consumer and removing the first data processing system from the data workflow interrupts the computer-implemented services if the operation of the digital twin does not replace the operation of the first data processing system.

3. The method of claim 1, wherein the data workflow comprises:
a data collector located in a first position in the data workflow;
the first data processing system located in a second position in the data workflow; and
a third data processing system located in a third position in the data workflow.

4. The method of claim 3, wherein the first updated data workflow comprises:
the data collector;
the digital twin located in a data center, the data center not being located in the second position in the data workflow; and
the third data processing system.

5. The method of claim 4, wherein there is a time delay between the occurrence of the event and the second data processing system becoming available for replacement of the first data processing system in the data workflow.

6. The method of claim 5, wherein initiating the operation of the digital twin comprises:
identifying a duration of the time delay; and
selecting characteristics of the digital twin based on the duration; and
temporarily substituting the operation of the digital twin for the operation of the first data processing system in the first updated data workflow for the duration,
wherein there is an expected difference in performance between the operation of the digital twin and the operation of the second data processing system.

7. The method of claim 6, wherein temporarily substituting the operation of the digital twin for the operation of the first data processing system comprises:
obtaining the digital twin based on the selected characteristics;
obtaining first input data for the digital twin from the data collector, the first input data being intended to be processed by the first data processing system in the data workflow;
obtaining first output data using the first input data and the digital twin; and
providing the first output data to the third data processing system.

8. The method of claim 7, wherein performing the analysis for the digital twin comprises:
obtaining second output data using the second data processing system and the first input data;
obtaining a difference between the second output data and the first output data; and
obtaining the digital twin performance report using, at least in part, the difference.

9. The method of claim 7, wherein performing the analysis for the digital twin comprises:
obtaining second output data using the second data processing system and second input data;
obtaining third output data using the digital twin and the second input data;
obtaining a difference between the second output data and the third output data; and
obtaining the digital twin performance report using, at least in part, the difference.

10. A non-transitory machine-readable medium having instructions stored therein, which when executed by a processor, cause the processor to perform operations for managing data processing systems responsible for performing a data workflow throughout a distributed environment, the operations comprising:
identifying an occurrence of an event indicating that a first data processing system of the data processing systems requires replacement in the data workflow;
based on the occurrence of the event:
initiating operation of a digital twin, the operation of the digital twin being intended to duplicate operation of the first data processing system, and the operation of the digital twin being substituted in the data workflow for the operation of the first data processing system in the data workflow to obtain a first updated data workflow;
after a second data processing system becomes available for replacement of the first data processing system, discontinuing use of the operation of the digital twin in the first updated data workflow and substituting operation of the second data processing system in the first updated data workflow for the operation of the digital twin in the first updated data workflow to obtain a second updated data workflow;
after obtaining the second updated data workflow:
performing an analysis for the digital twin and based on test operation of the second data processing system and test operation of the digital twin to obtain a digital twin performance report; and
performing an action set based on the digital twin performance report.

11. The non-transitory machine-readable medium of claim 10, wherein the data workflow facilitates providing computer-implemented services to a downstream consumer and removing the first data processing system from the data workflow interrupts the computer-implemented services if the operation of the digital twin does not replace the operation of the first data processing system.

12. The non-transitory machine-readable medium of claim 10, wherein the data workflow comprises:
a data collector located in a first position in the data workflow;
the first data processing system located in a second position in the data workflow; and
a third data processing system located in a third position in the data workflow.

13. The non-transitory machine-readable medium of claim 12, wherein the first updated data workflow comprises:
the data collector;
the digital twin located in a data center, the data center not being located in the second position in the data workflow; and
the third data processing system.

14. The non-transitory machine-readable medium of claim 13, wherein there is a time delay between the occurrence of the event and the second data processing system becoming available for replacement of the first data processing system in the data workflow.

15. The non-transitory machine-readable medium of claim 14, wherein initiating the operation of the digital twin comprises:
identifying a duration of the time delay; and
selecting characteristics of the digital twin based on the duration; and
temporarily substituting the operation of the digital twin for the operation of the first data processing system in the first updated data workflow for the duration,
wherein there is an expected difference in performance between the operation of the digital twin and the operation of the second data processing system.

16. A data processing system, comprising:
a processor; and
a memory coupled to the processor to store instructions, which when executed by the processor, cause the processor to perform operations for managing data processing systems responsible for performing a data workflow throughout a distributed environment, the operations comprising:
identifying an occurrence of an event indicating that a first data processing system of the data processing systems requires replacement in the data workflow;
based on the occurrence of the event:
initiating operation of a digital twin, the operation of the digital twin being intended to duplicate operation of the first data processing system, and the operation of the digital twin being substituted in the data workflow for the operation of the first data processing system in the data workflow to obtain a first updated data workflow;
after a second data processing system becomes available for replacement of the first data processing system, discontinuing use of the operation of the digital twin in the first updated data workflow and substituting operation of the second data processing system in the first updated data workflow for the operation of the digital twin in the first updated data workflow to obtain a second updated data workflow;
after obtaining the second updated data workflow:
performing an analysis for the digital twin and based on test operation of the second data processing system and test operation of the digital twin to obtain a digital twin performance report; and
performing an action set based on the digital twin performance report.

17. The data processing system of claim 16, wherein the data workflow facilitates providing computer-implemented services to a downstream consumer and removing the first data processing system from the data workflow interrupts the computer-implemented services if the operation of the digital twin does not replace the operation of the first data processing system.

18. The data processing system of claim 16, wherein the data workflow comprises:
a data collector located in a first position in the data workflow;
the first data processing system located in a second position in the data workflow; and
a third data processing system located in a third position in the data workflow.

19. The data processing system of claim 18, wherein the first updated data workflow comprises:
the data collector;
the digital twin located in a data center, the data center not being located in the second position in the data workflow; and
the third data processing system.

20. The data processing system of claim 19, wherein there is a time delay between the occurrence of the event and the second data processing system becoming available for replacement of the first data processing system in the data workflow.
